(19) United States
(12) Patent Application Publication
(10) Pub. No.: US 2016/0008741 A1
(43) Pub. Date: Jan. 14, 2016

(54) FLUID SEPARATOR

(71) Applicant: CALTEC LIMITED, Bedfordshire (GB)

(72) Inventors: Mirza Najam Ali Beg, Milton Keynes (GB); Mir Mahmood Sarshar, Beaconsfield (GB); Raja Kishore Nalukurthy, Rushden (GB)

(21) Appl. No.: 14/380,069

(22) PCT Filed: Feb. 12, 2013
(86) PCT No.: PCT/GB13/50313

§ 371 Date: Aug. 20, 2014

(30) Foreign Application Priority Data
Feb. 21, 2012 (GB) 1203064.9

(51) Int. Cl. B01D 19/00; C02F 1/20; B01D 17/02; B04C 9/00; B04C 5/04

(52) U.S. Cl. CPC B01D 19/0057; B04C 9/00; B04C 5/04; B01D 17/0208; C02F 1/20; C02F 2001/007

(57) ABSTRACT

A fluid separator includes a gravity separation chamber (4) including an inlet duct (2) for a mixture of gas and liquid, and a cyclonic inlet diverter (D) located within the gravity separation chamber. The cyclonic inlet diverter (D) includes a cyclonic inlet chamber (18) connected to receive a mixture of gas and liquid from the inlet duct (2), a cyclonic separation chamber (20), a gas outlet (22) at an upper end of the cyclonic separation chamber and a liquid outlet (24) at a lower end of the cyclonic separation chamber. The cyclonic inlet chamber (18) has an involute configuration.

The present invention relates to a fluid separator and in particular, but not exclusively, to a fluid separator for use in the oil and gas industries. More specifically, the present invention relates to a gravity separator and an inlet diverter device for a gravity separator.

Gravity separators which receive a mixture of gas and oil or water for two-phase (gas-liquid) or three phase (gas-oil-water) separation duties are generally equipped with an inlet diverter. The inlet diverter has the main function of absorbing or dissipating the energy of the fluid flow as it enters the separator through an inlet nozzle. Dissipation of the momentum of the flow has the benefit of allowing the flow to pass through the separator at low velocity without a jetting action at entry into the separator, which will be experienced if the flow enters the separator without losing its momentum and at a high velocity.

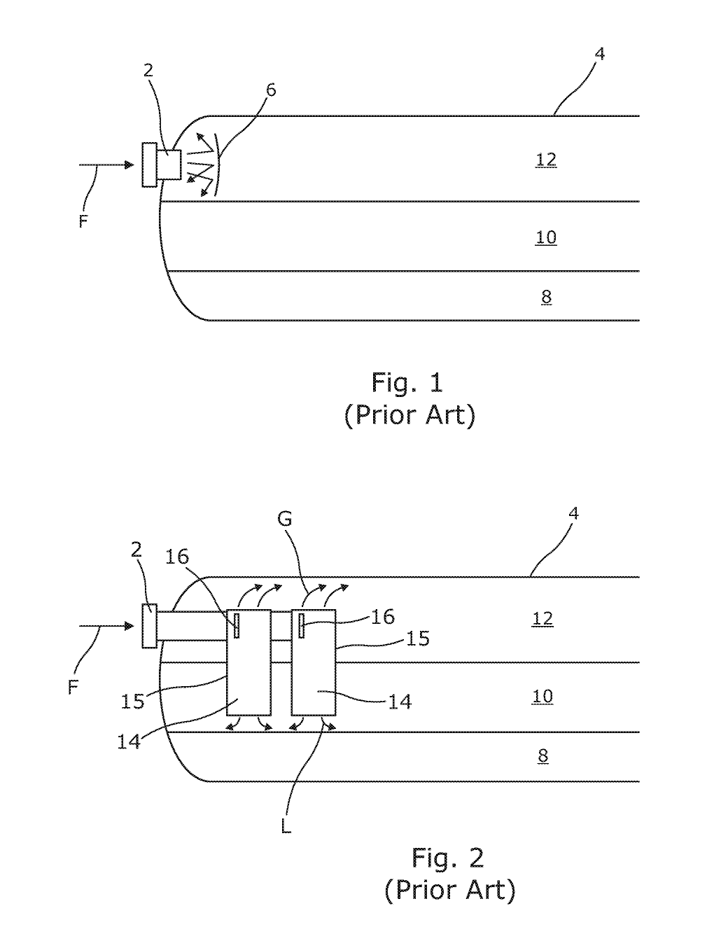

Some early diverter devices use a dish type diverter as shown in FIG. 1, in which the mixture of fluids F flowing through the inlet duct 2 of the gravity separator 4 are deflected by a shallow dish diverter 6 before settling within the gravity separator 4 to form layers of water 8, oil 10 and gas 12. However, these dish diverters 6 are not very efficient as their configuration caused splashing of the fluid mixture as it hits the inlet diverter dish 6. Therefore, although the momentum of the fluid mixture F is dissipated, the diverter 6 also causes violent splashing of the flow around the diverter. This splashing of the mixture affects separation efficiency and causes turbulence in the flow at the inlet end of the gravity separator 4, instead of streamlining the flow.

In later gravity separators, inlet diverter devices of a different type were introduced, which consist of one or more cyclonic separators. As shown in FIG. 2, each cyclonic separator 14 is connected to the inlet duct 2 to receive the fluid mixture F flowing into the gravity separator 4. Each cyclonic separator 14 comprises an open ended cylindrical separation vessel 15 having a tangential inlet 16. The mixture of fluids enters the separation vessel 14 through the tangential inlet 16 and is directed along the inner surface of the cylindrical separation vessel 15 to form a cyclone, which causes centrifugal separation of the gases and liquids. The liquids L then escape from the separation chamber 15 through its lower end while the separated gases G escape from its upper end.

An example of a prior art gravity separator having a cyclonic inlet diverter is described in U.S. Pat. No. 4,778,494. The cyclonic inlet diverter includes a cylindrical chamber with a tangential fluid inlet. The chamber is closed at its lower end and liquid rotating within the chamber escapes by flowing over the upper edge of the cylindrical chamber wall. Gases separated from the liquid leave the chamber through an axial vent at its upper end.

An advantage associated with the use of a cyclonic inlet diverter, in addition to absorbing part of the momentum of the flow, is that it also provides an initial partial separation (or “conditioning”) of gas and liquid phases, which helps the gravity separator with the function of gas-liquid separation. However, the high rotational velocities of the separated gas and liquid streams as they leave the inlet diverter and enter the gravity separator can cause turbulence, which adversely affects gravitational separation.

Certain objects of the present invention are to provide a fluid separator and an inlet diverter device for a fluid separator, which mitigate one or more of the aforesaid disadvantages.

According to one aspect of the present invention there is provided a fluid separator comprising a gravity separation chamber having an inlet duct for a mixture of gas and liquid, and a cyclonic inlet diverter located within the gravity separation chamber, the cyclonic inlet diverter including a cyclonic inlet chamber connected to receive a mixture of gas and liquid from the inlet duct, a cyclonic separation chamber, a gas outlet at an upper end of the cyclonic separation chamber and a liquid outlet at a lower end of the cyclonic separation chamber, wherein the cyclonic inlet chamber has an involute configuration.

The cyclonic inlet diverter effectively dissipates the momentum of the inlet fluids while maintaining streamlined flow. This makes it possible to introduce the fluids into the gravity separator without causing turbulence. The fluid flow is then conditioned in the cyclonic separation chamber, which provides partial cyclonic separation of the gas and liquid phases and aids gravitational separation within the gravity separator. As a result, the gravity separator is able to operate with greater efficiency.

The involute inlet chamber is defined by curved wall of gradually decreasing radius. The involute shape of the inlet chamber may for example be similar to that described in patent application WO99/22873A, the contents of which are incorporated by reference herein. This provides an inlet duct that gradually increases in curvature and decreases in cross-sectional area in the direction of fluid flow. As a result, the speed and radial acceleration of the fluids increase as they flow through the involute inlet chamber, providing for efficient cyclonic separation of the gases and liquids in the fluid mixture while maintaining streamlined flow.

The cyclonic inlet chamber is preferably mounted at an upper end of the cyclonic separation chamber so that the rotating fluids flow downwards into the cyclonic separation chamber.

Advantageously, the cyclonic separation chamber comprises a substantially cylindrical chamber. The cyclonic separation chamber may include a frusto-conical chamber at its upper end having a radius that decreases in the upwards direction and/or a frusto-conical chamber at its lower end having a radius that decreases in the downwards direction.

Advantageously, the fluid separator includes a liquid outlet chamber at the lower end of the cyclonic separation chamber. The liquid outlet chamber preferably includes a substantially cylindrical chamber that is closed at its lower end and has an annular liquid outlet at its upper end. The liquid outlet chamber preferably includes vortex breakers for reducing the rotational speed of liquids within the chamber.

The liquid outlet of the cyclonic separation chamber is preferably located below the operational liquid level of the gravity separation chamber to prevent separated gases from flowing through the liquid outlet.

Advantageously, the gas outlet of the cyclonic separation chamber comprises an outlet duct having an inlet end located axially within the cyclonic separation chamber. In one embodiment, the outlet duct includes at least one elbow joint to reduce the rotational speed of gases passing through the duct.

Advantageously, the outlet duct has an outlet end configured to direct a gas stream flowing through the outlet duct against a gas diverter device, which is configured to divert the gas stream and to cause liquid droplets entrained within the gas stream to coalesce. The gas diverter device may for example consist of one or more curved plates.

In a preferred embodiment, the fluid separator includes a plurality of cyclonic inlet diverters and a transfer duct configured to transfer a mixture of gas and liquid from the inlet duct to the respective cyclonic inlet chambers of the cyclonic inlet diverters.

According to another aspect of the invention there is provided a cyclonic inlet diverter for use in a gravitational fluid separator, the cyclonic inlet diverter being configured to be located within the gravitational fluid separator and including a cyclonic inlet chamber configured for connection to an inlet duct of the gravitational fluid separator, a cyclonic separation chamber, a gas outlet at an upper end of the cyclonic separation chamber and a liquid outlet at a lower end of the cyclonic separation chamber, wherein the cyclonic inlet duct has an involute configuration.

The cyclonic inlet diverter may include one or more of the features set out in the preceding statements of invention.

In a preferred embodiment of the present invention, the inlet diverter has unique features that help to eliminate any turbulence of the flow as the separated gas and liquid phases exit the diverter. It also helps to separate the gas and liquid phases as the mixture passes through the inlet diverter. Preferably, the inlet diverter of the present invention is installed inside the gravity separator close to the fluid entry end of the separator.

Certain embodiments of the invention will now be described by way of example with reference to the accompanying drawings, in which:

FIG. 1 is a schematic side section of a first prior art gravity separator having a dish type inlet diverter;

FIG. 2 is a schematic side section of a second prior art gravity separator having a multi-cyclone inlet diverter;

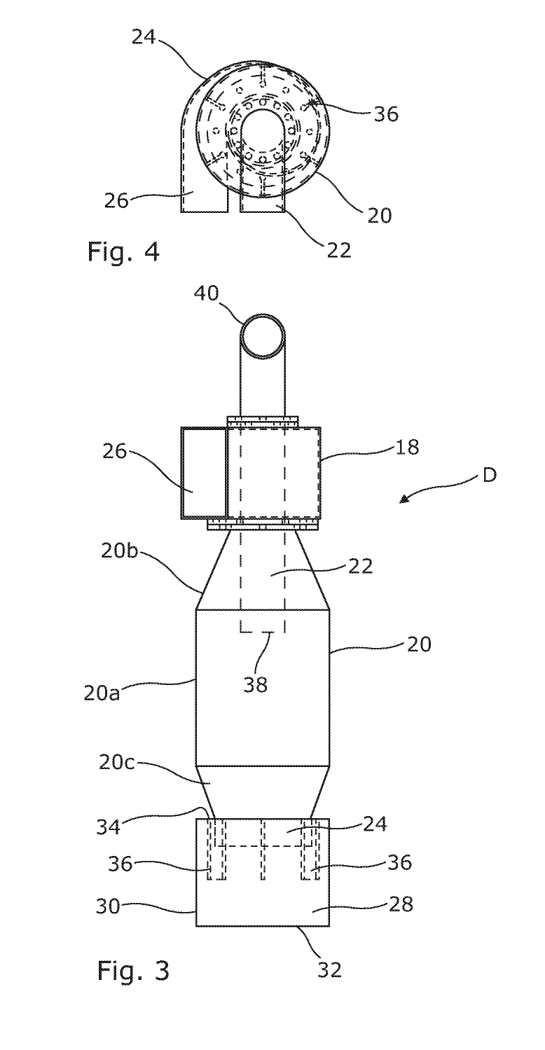

FIG. 3 is a part sectional side view of a cyclonic inlet diverter according to a first embodiment of the invention;

FIG. 4 is a part sectional plan view of the cyclonic inlet diverter of FIG. 3;

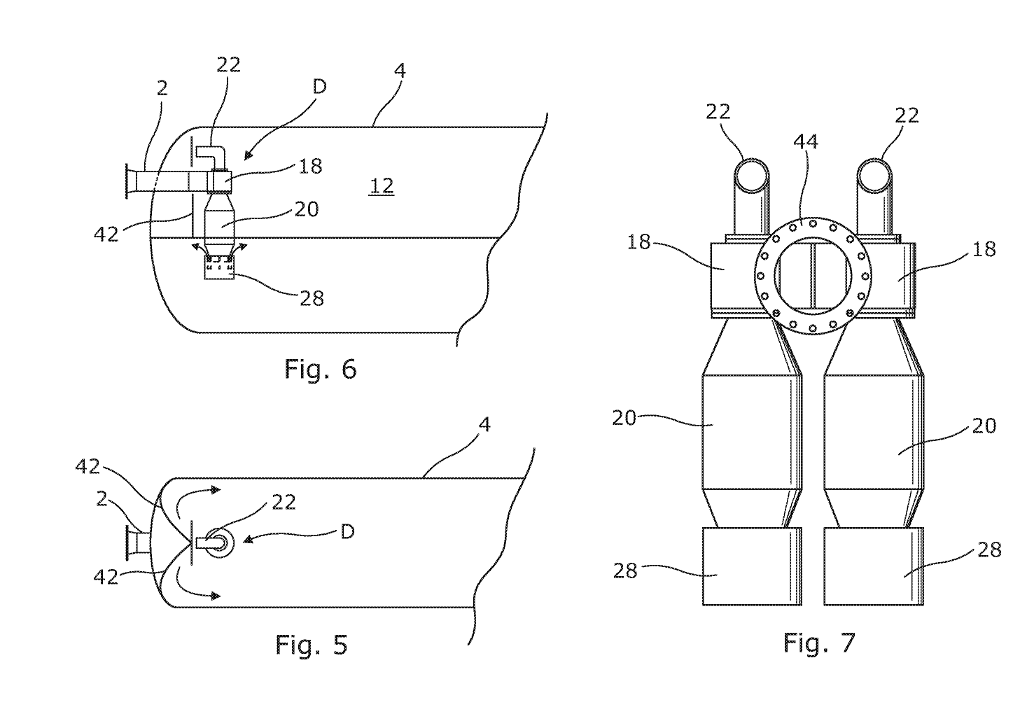

FIG. 5 is a sectional top plan view of a gravity separator having a cyclonic inlet diverter of the type shown in FIGS. 3 and 4;

FIG. 6 is a side sectional view of the gravity separator shown in FIG. 5;

FIG. 7 is a front view of a multiple cyclonic inlet diverter according to a second embodiment of the invention;

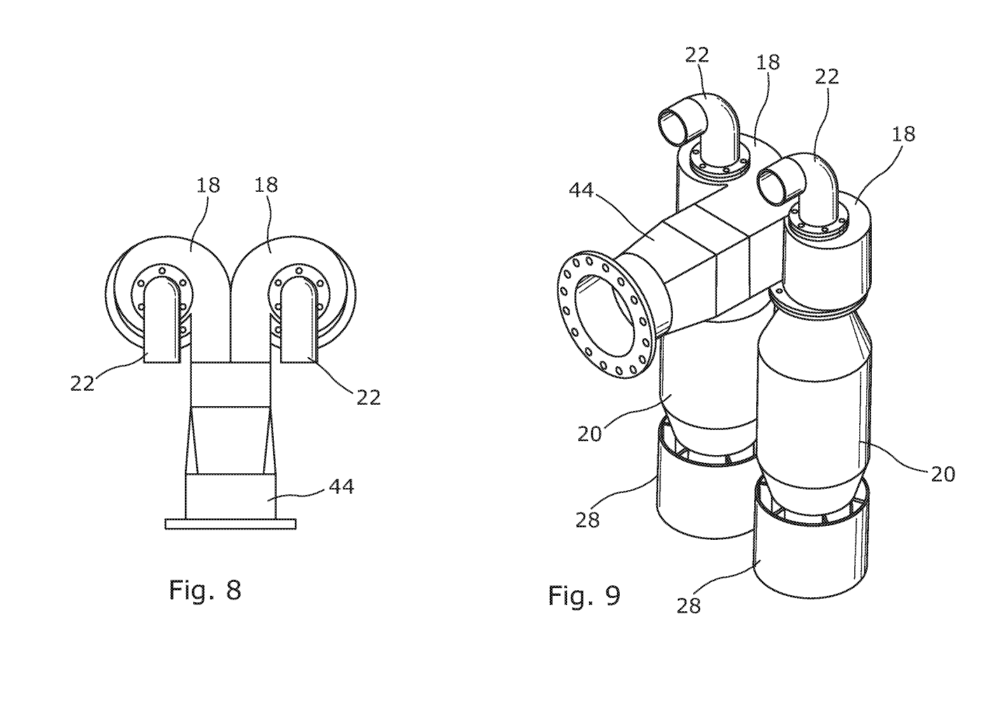

FIG. 8 is a top plan view of the cyclonic inlet diverter shown in FIG. 7;

FIG. 9 is an isometric view of the cyclonic inlet diverter shown in FIG. 7;

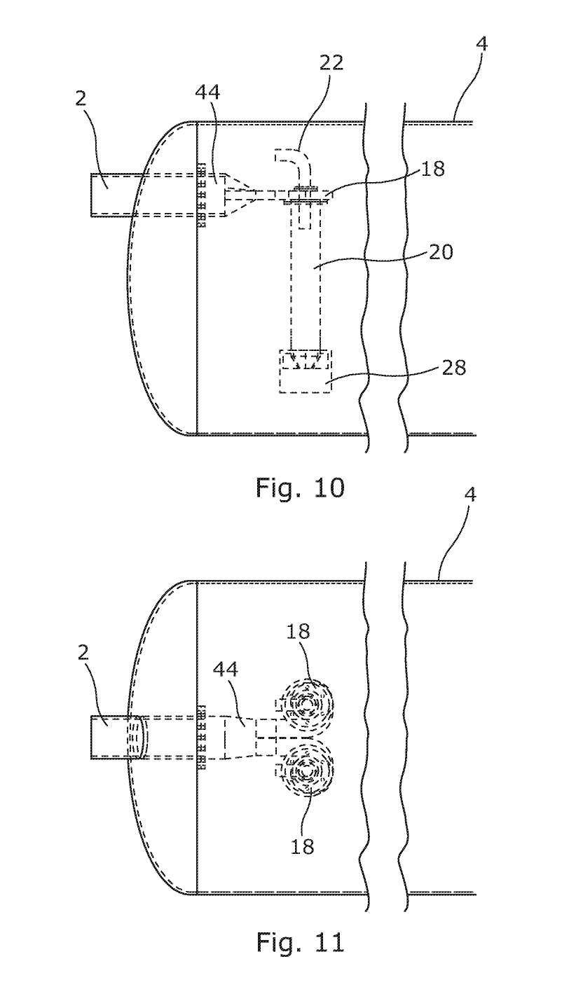

FIG. 10 is a side sectional view of a gravity separator having a cyclonic inlet diverter similar to that shown in FIGS. 7 to 9; and

FIG. 11 is a sectional top plan view of the gravity separator shown in FIG. 10.

The cyclonic inlet diverter D shown in FIGS. 3 and 4 comprises an adaptation of the compact cyclonic separator described in international patent application WO99/22873A, the content of which is incorporated by reference herein. The separator described in WO99/22873A was developed to perform the main duty of two-phase, gas-liquid separation or liquid-sand separation. In the present invention this device is modified to work as an effective cyclonic inlet diverter, allowing it to perform two important duties: absorbing/dissipating the momentum of the fluid flow entering the gravity separator, and performing an initial separation of gas and liquid phases.

FIGS. 3 and 4 show the key features of this inlet diverter device D. It includes a cyclonic inlet chamber 18 that is connected to receive a mixture of gas and liquid from the inlet duct 2 of the gravity separator 4. Below the cyclonic inlet chamber 18 is a cyclonic separation chamber 20 having a gas outlet 22 at an upper end of the cyclonic separation chamber and a liquid outlet 24 at a lower end of the cyclonic separation chamber.

The cyclonic inlet chamber 18 has an involute configuration, as shown most clearly in FIG. 4. The involute inlet chamber 18 is defined by curved wall 24 of gradually decreasing radius, which provides an inlet duct 26 that decreases in radius and cross-sectional area in the direction of fluid flow. The curved wall 24 extends through 360 degrees around the axis of the chamber, the upper side of the inlet chamber 18 being closed by a plate and the lower side opening into the cyclonic separation chamber 20.

The cyclonic separation chamber 20 comprises a central section 20a defined by a substantially cylindrical chamber wall, an upper section 20b defined by a frusto-conical chamber wall having a radius that decreases in the upwards direction, and lower section 20c defined by a frusto-conical chamber wall having a radius that decreases in the downwards direction.

A liquid outlet chamber 28 is provided at the lower end of the cyclonic separation chamber 20. The liquid outlet chamber 28 includes a substantially cylindrical chamber wall 30 that is closed at its lower end by a plate 32 and has an annular liquid outlet 34 at its upper end. A plurality of vortex breakers 36 in the form of vertically mounted plates are provided within the liquid outlet chamber 28 for reducing the rotational speed of liquid in the chamber.

The liquid outlet of the cyclonic separation chamber 20 is located below the operational liquid level of the gravity separation chamber 4 so that liquid leaving the outlet chamber 28 flows into the body of liquid 10 within the gravity separator, below the liquid surface. This prevents separated gases from being discharged through the liquid outlet.

The gas outlet 22 of the cyclonic separation chamber comprises an outlet duct having an inlet end 38 located axially within the cyclonic separation chamber 20. The outlet duct includes at least one elbow joint 40 at its upper end that helps to reduce the rotational speed of the gases as they pass through the duct.

A mixture of produced fluids consisting for example of water, oil and gas enters the cyclonic inlet diverter 17 via the inlet duct 2. As the fluid flow passes through the involute inlet duct 26 it starts to rotate, generating high “g” forces. The gradual reduction in the radius and cross-sectional area of the involute increases the speed and radial acceleration of the fluids as they enter the separation chamber 20.

The fluids continue to rotate as they enter the cyclonic separation chamber 20. The cyclonic action conditions the fluids and causes partial centrifugal separation of the liquid and gas phases. The liquid phase flows downwards into the liquid outlet chamber 28 and the vortex breakers 36 serve to reduce the rotational velocity of the liquid phase as it enters the liquid outlet chamber 28, which serves as a flow regulating device. The liquid phase then flows upwards through the annular outlet 34 into the body of liquid 10 within the gravity separation chamber 4.

In this embodiment the separation chamber 20 has a first conical section 20b at its upper end where it joins the involute inlet chamber 18 and a second conical section 20c at its lower end. The upper conical section 20b serves to match the diameter of the involute inlet chamber 18 with that of the separation chamber 20. The lower conical section 20c helps to maintain the spinning action of the fluids at the lower end of the chamber 20 where most of the gas phase has already been separated in the upper section of the separation chamber 20.

The cylindrical liquid outlet chamber 28 is closed at its base, thus forcing the spinning liquids to rise and exit through the annulus 34 between the separation chamber 20 and the outlet chamber 28. The function of the outlet chamber 28 is to ensure that liquids exit the inlet diverter without any significant rotational velocity, so that the flow enters the main gravity separator gently with no spinning motion and without causing excessive turbulence, which would otherwise affect the separation efficiency of the gravity separator.

As shown in FIG. 6, in use the separation chamber 20 is partially submerged in the liquid phase 10 of the gravity separator 4, preferably to at least ⅓^{rd} of its height. The cylindrical outlet chamber 28 is fully submerged in the liquid phase 10 of the gravity separator. This prevents the separated gas escaping through the lower section 20c of the separation chamber 20.

The separated gas is captured by a gas outlet duct 22 known as a vortex finder, which is located near the top end of the separation chamber 20. The gas outlet duct 22 is installed in the middle section 20a of the separation chamber 20 and preferably extends below the bottom section of the involute inlet chamber 18 by a distance at least equal to the depth of the involute inlet chamber 18. The gas outlet duct 22 preferably includes an elbow 40 to divert the separated gas flowing through the device and to absorb the energy and momentum of the separated gas.

The separated gas may still contain some liquid droplets of various sizes as the separation efficiency of the inlet diverter is not perfect and because of the nature of the flow into the separator, which in most cases consists of a fluctuating or slugging flow regime. The liquid carry-over in the gas phase depends on the severity of the flow regime or the severity of flow fluctuations of fluids entering the separator.

The separated gas passing through the gas outlet duct 22 and elbow 40 still has a high axial velocity and some spinning motion caused by the action of the involute inlet chamber 18. It is desirable to dissipate both motions so that the separation of liquid droplets carried through the upper half of the main gravity separator with the separated gas is easier and more efficient.

As illustrated in FIGS. 5 and 6, the outlet end of the gas outlet duct 22 is configured to direct the gas stream flowing out through the outlet duct 22 against a gas diverter device 42 comprising a pair of curved diverter plates mounted adjacent the inlet end of the gravity separator 4. The diverter plates 42 are configured to divert the gas stream and to cause liquid droplets entrained within the gas stream to coalesce and fall back into the body of liquid 10 within the gravity separator 4. The diverter plates 42 ensure that gas exiting the gas outlet duct 22 enters tangentially onto the surface of the gas diverter plates 42.

The function of the gas diverter device 42 is to divert the gas tangentially and gently back towards the gas outlet end of the main gravity separator 4. This device also by its curved shape helps to retain the liquid droplets contained in gas and causes them to coalesce. The liquid collected by gas diverter plates 42 drops down into the liquid phase of the gravity separator 4. The diverter plates 42 extend to below the liquid level in the gravity separator by at least 15 cm to avoid splashing of the collected liquid onto the surface of the liquid body 10 in the gravity separator 4.

The gas diverter device 42 can alternatively be orientated to point upwards so that the separated gas spreads along the upper surface (or roof) of the gravity separator 4. In this case the elbow 40 in the duct 22 may be removed so that the gas impinges on the diverter plates 42 directly from the gas outlet duct 22.

The cyclonic inlet diverter D is held in position by a number of brackets (not shown) attached to the body of the gravity separator 4 to hold it safely and to prevent excessive vibration caused by the momentum and force of the fluctuating flow of fluids entering the device.

The inlet diverter D can be a single unit with its size generally limited to a foot print which enables the unit to pass as a whole or in sections through a 24″ (60 cm) manhole for installation inside a gravity separator. This limitation is mainly dictated by the size of the involute inlet chamber 18 and the cylindrical separation chamber 20 and is designed purely to enable retrofitting of the device to an exiting gravity separator by passing it through a standard 24″ (60 cm) manhole.

The above description of the system relates to a single inlet diverter unit. Each inlet diverter unit has a capacity for handling a known volumetric flow rate of gas and liquid mixture. The limit is dictated by the operating pressure and gas volume fraction of the mixture at the operating pressure and temperature. The limit for flow rate of the mixture passing through each inlet diverter is also selected to minimise pressure loss through the unit to a fraction of a bar (4 to 6 Psi typical) and to allow the diverter to operate satisfactorily under a turn-down condition approximately equal to ⅕^{th} of its normal design rate. This limit is purely to ensure that even at turn down there is sufficient cyclonic force (spinning action) generated by the flow to achieve the desired gas-liquid separation through the cyclonic inlet diverter.

A multi-unit version, shown in FIGS. 7 to 9, enables a number of standard units to be installed to cover flow rates much bigger than the capacity of a single inlet diverter. In this embodiment, two cyclonic inlet diverters D are provided, which operate in parallel with each other. A common inlet duct 44 is provided, which divides a flow of fluids between the cyclonic inlet chambers 18 of the two inlet diverters D. The involute inlet chambers 18 turn in opposite directions, allowing them to be bolted side-by-side.

The number of inlet diverter units that can be assembled can for example be two, four or six to cover high flow rates of the mixture. In cases where the main separator has to handle very large mixture flow rate, it is possible to design a larger inlet diverter unit so that by using a number of the larger units, much higher flow rates can be handled by the bundle of inlet diverter units.

The typical capacity for the standard single unit varies depending on a number of factors including the operating pressure, the gas volume fraction (GVF) of the mixture at the operating pressure and temperature and the acceptable level of pressure loss across the unit. A typical operating range for a fluid mixture (liquid and gas) flow rate is 12,500 to 25,000 actual m³/day at the operating pressure and temperature. In terms of liquids flow rate, the flow rate capacity is between 2500 and 4000 m³/d (15,000 to 25,000 barrels/day approximately). Smaller units for flow rates ranging between 5000 to 15,000 b/d of liquids can be designed by scaling down the unit. The range quoted for the liquids flow rate is in part dictated by the gas volume fraction of the mixture at the operating pressure and temperature

In the case of multiple units, the system is designed so that two or more units can be joined together with the connecting plate sections bolted together. This feature still allows all parts to be passable through a 24″ (60 cm) manhole for assembly inside the main gravity separator.

When more than one unit is used, as shown in FIGS. 10 and 11, each unit can be arranged such that the two units share a common enlarged inlet duct 10, which is rectangular in shape and includes a transition section 11 to convert the shape to a circular form so that it can be connected to the inlet flanged section 12. Sections 10 and 11 can be manufactured as separate units and can be assembled and join the involute inlets 1 by bolts or equivalent inside the gravity separator. The capacity of the two combined units will be twice that of a single unit. The capacity of an assembly consisting of four units will be four times that of the single unit.

1. A fluid separator comprising a gravity separation chamber including an inlet duct for a mixture of gas and liquid, and a cyclonic inlet diverter located within the gravity separation chamber, the cyclonic inlet diverter including a cyclonic inlet chamber connected to receive a mixture of gas and liquid from the inlet duct, a cyclonic separation chamber, a gas outlet at an upper end of the cyclonic separation chamber and a liquid outlet at a lower end of the cyclonic separation chamber, wherein the cyclonic inlet chamber includes a curved inlet duct of decreasing radius for inducing fluids flowing through the chamber to swirl around an axis.

2. A fluid separator according to claim 1, wherein the cyclonic inlet chamber is mounted at an upper end of the cyclonic separation chamber.

3. A fluid separator according to claim 1, wherein the curved inlet duct has a decreasing cross-sectional area.

4. A fluid separator according to claim 1, wherein the curved inlet duct has an involute shape.

5. A fluid separator according to claim 1, wherein the curved inlet duct extends around approximately 360°.

6. A fluid separator according to claim 1, wherein the cyclonic separation chamber comprises a substantially cylindrical chamber.

7. A fluid separator according to claim 6, wherein the cyclonic separation chamber includes a frusto-conical chamber wall at its upper end having a radius that decreases in the upwards direction.

8. A fluid separator according to claim 6, wherein the cyclonic separation chamber includes a frusto-conical chamber wall at its lower end having a radius that decreases in the downwards direction.

9. A fluid separator according to claim 1, further comprising a liquid outlet chamber at the lower end of the cyclonic separation chamber.

10. A fluid separator according to claim 9, wherein the liquid outlet chamber includes a substantially cylindrical chamber that is closed at its lower end and has an annular liquid outlet at its upper end.

11. A fluid separator according to claim 9, wherein the liquid outlet chamber includes vortex breakers for reducing the rotational speed of liquids within the liquid outlet chamber.

12. A fluid separator according to claim 1, wherein the liquid outlet of the cyclonic separation chamber is located below the operational liquid level of the gravity separation chamber.

13. A fluid separator according to claim 1, wherein the gas outlet of the cyclonic separation chamber comprises an outlet duct having an inlet end located axially within the cyclonic separation chamber.

14. A fluid separator according to claim 13, wherein the outlet duct includes at least one elbow joint.

15. A fluid separator according to claim 13, wherein outlet duct has an outlet end configured to direct a gas stream flowing through the outlet duct against a gas diverter device.

16. A fluid separator according to claim 1, further including a plurality of cyclonic inlet diverters and a transfer duct configured to transfer a mixture of gas and liquid from the inlet duct to the respective cyclonic inlet chambers of the cyclonic inlet diverters.

17. A cyclonic inlet diverter for use in a gravitational fluid separator, the cyclonic inlet diverter being configured to be located within the gravitational fluid separator and comprising:
a cyclonic inlet chamber configured for connection to an inlet duct of the gravitational fluid separator,
a cyclonic separation chamber,
a gas outlet at an upper end of the cyclonic separation chamber and a liquid outlet at a lower end of the cyclonic separation chamber,
wherein the cyclonic inlet duct includes a curved inlet duct of decreasing radius for inducing fluids flowing through the chamber to swirl around an axis.

18. (canceled)
